(19) United States
(12) Patent Application Publication
(10) Pub. No.: US 2009/0083198 A1
(43) Pub. Date: Mar. 26, 2009

(54) Process for franking, printing, and/or producing images on flat mail items

(76) Inventor: Thomas Peter Haug, Langnau im Emmental (CH)

Correspondence Address: Friedrich Kueffner, Suite 910, 317 Madison Avenue, New York, NY, 10017, US

(21) Appl. No.: 12/231,548

(22) Filed: Sep. 3, 2008

(30) Foreign Application Priority Data
Sep. 7, 2007 (EP) 07 405 269.7

(51) Int. Cl. G07B 17/02; G06F 17/00

(52) U.S. Cl. 705/406; 209/539

(57) ABSTRACT

Mail items (3) are supplied individually to, through, and away from a device (1) for franking and/or printing images on flat mail items (3) by a franking system (2) which indicates a franking unit (4) for franking and/or printing images on the mail items (3). Conveyor system (7) is assigned to the franking system (2), the end of the conveyor system leading to a transport system (10), installed underneath the franking system (2) for receiving the mail items (3) for further transport and driven in a transport direction opposite to that in which the mail items (3) to be franked are conveyed in the franking system (2).

### BACKGROUND OF THE INVENTION

1. Field of the Invention

The present invention relates to a process for franking, printing, and/or producing images on flat mail items such as envelopes, cards, mailers, labels, printed products, etc., by means of a franking system which includes a conveyor system for conveying the mail items through the franking system. The conveyor system conveys the mail items in a row but a certain distance apart to a franking operation and then, after the franking, carries away the mail items, certain areas of which have been franked, printed, and/or provided with images, either individually or in an imbricated stream.

2. Description of the Related Art

In franking systems, large quantities or runs of mail items often lead to the situation that a single person can no longer manage the work required to maintain maximum throughput.

It is known that this can be done, for example, by conveying the mail objects in an imbricated stream after they have been franked and by removing them in the form of bundles or stacks at the end of the conveying route. No account is taken of the fact, however, that, as a result of this measure, the freshly printed fields or areas on the mail items will be smeared to the point of illegibility, because, as the imbricated row is formed, the mail item arriving from the rear makes contact with the franked mail object in front in an uncontrolled manner and thus generates a sliding, frictional effect.

Also unsatisfactory is a known design in which, after the franked envelopes or mail items have left the franking system, they are transferred to a transport stream extending transversely to the conveying direction. This approach, however, does not make it possible to create an imbricated stream of slender formats such as C5 in such a way that the freshly printed fields on the mailing items are kept reliably free. In addition, such an arrangement occupies a large amount of space and demands a great deal of work on the part of the operator.

### SUMMARY OF THE INVENTION

It is the object of the present invention is to subject the freshly franked mail items to further processing in such a way that in particular the postage and/or advertising or other information printed on them remains undamaged.

According to the invention, the object is achieved in that the mail items leaving the franking system in a row a certain distance apart from each other are transferred by way of a free-fall drop-off to a preferably imbricated stream, in which the distance between the individual mail items is at least approximately equal to the size of the freshly printed, franked area on the mail item.

As a result, it is possible without loss of output to continue to transport a large quantity of mail items, both one by one and in an imbricated stream, and to prevent the printing from being smeared, rubbed off, or made unrecognizable.

When the proposed process is used, a preferred embodiment for forming an imbricated stream consists in transferring the mail items by way of the free-fall drop-off to an imbricated stream, which is located underneath the franking system and which proceeds in a transport direction opposite to the conveying direction of the franking system, the distance between the transported mail items in the longitudinal direction of the imbricated stream being at least approximately equal to the franked length of the mail items.

The imbricated stream is advisably formed by reducing the transport speed after the mail items have been franked, that is, by transporting them at a speed slower than that at which they were conveyed during the franking operation and individually printed.

It should be noted in this context that the number of items to be processed is usually large and that the mail items are usually all of the same format. If mail items of different lengths are processed along the conveying route of the franking system, it would be advantageous to provide a monitoring system which can detect and evaluate the different lengths of the mail items during franking and then control the formation of the imbricated stream as required.

It is also proposed that the formation of the imbricated stream be supported by a stop, which is inserted into the path of the mail items leaving the franking system to form gaps between the mail items. The stop can capture the mail objects or position them and, in the case of a transport direction which is transverse to the conveying direction during franking, it can start them moving sideways.

The present invention also relates to a device for franking, printing, and/or producing images on flat mail items by means of a franking system, the device including a franking unit for franking and/or for producing images on the mail items, which are fed individually to the franking unit, conducted through it, and carried away from it, where a conveying system forming a franking line is assigned to the franking unit, the conveying end of this line leading to a transport system.

Franking systems are set up on flat support surfaces or tables and are freely accessible over their length to the operator. The increasing numbers of flat mail items such as letters, cards, and printed matter of all kinds demand higher processing speeds, but as a result the output of the franking systems can no longer be managed by one operator. Technical improvements are therefore needed. Among other things, the collecting containers located at the end of the franking system are unable to process these large numbers of franked mail items or are unable to prepare them for further processing especially when the mail items are automatically supplied individually from a stack to a franking and/or printing unit. This situation has caused designers of franking systems to equip the latter with a transport system at the end of the conveyor, this transport system being designed to form an imbricated stream of the franked and/or printed mail items. This measure makes it possible to transport or accept and/or process more mail items along an additional transport route at reduced speed. This partial success leads to the disadvantages that the length of the franking system is made longer by this extra transport distance and that the freshly franked mail items come to rest on top of each other in the imbricated stream in such a way that, by sliding over the franked or printed item in front, the item at the rear can smear the printing or postage mark located in the trailing area of the item in front, i.e., in the downstream area with respect to the conveying direction.

This situation cannot be remedied even by carrying the mail items away in a direction perpendicular to the conveying direction of the conveyor device of the franking system.

Thus it is no longer guaranteed that the mail item can be read or processed later by machine, nor is the need for additional working space eliminated.

According to the object of the present invention, the disadvantages described above are to be eliminated and a device is to be created by means of which the franked and/or printed mail items can be carried away without trouble in a more economical manner.

According to the invention, this object is achieved in that the transport system designed to accept the mail items is installed underneath the franking system and is driven in the direction opposite to that in which the mail items to be franked by the franking system are traveling.

By simply laying the following mail items down on unprinted areas of the preceding mail items, it thus becomes possible to transport the franked mail items either individually or in an imbricated stream without the printed postage marks on the items in front being damaged or rendered illegible by the mail items coming up from the rear and without interfering with the franking process. The inventive solution obviously makes it possible to continue to transport the mail items individually after they have been franked and/or printed. The essential feature, however, is that the mail items remain protected from any effects of the transport process which could smear or rub off the printing or otherwise render it illegible, and that they can thus be subjected to further processing in the desired form.

It has been found advantageous to use a preferably undershot transport system, which consists of an endless transport belt traveling between two axles a certain distance apart, one of which is driven. The belt forms a transport surface which is more-or-less parallel to the conveying line of the conveyor system assigned to the franking system.

Instead of a transport belt, it is also possible to use transport rolls as a transport system, the rolls being arranged transversely to the transport direction and placed adjacent to each other in a row extending in the transport direction, where the transport rolls can be connected to each other for drive purposes by driven tension means such as a roller chain or a drive belt.

So that the transport system can be adjusted to suit the selected transport configuration of the mail items on the transport system and to suit the speed at which the mail items leaving the franking system are being conveyed, the transport system can be designed to be movable and adjustable along the length of the conveying line consisting of the feed or loading section above the franking system, the franking and/or printing section, and the outfeed section of the franked mail items. This does not mean, however, that the outfeed end of the transport system projects beyond the upstream conveying end of the franking system, i.e., the infeed end of the conveyor system, even though, with respect to the removal of the mail objects, this could be advantageous for the further handling of the franked mail items.

In an elaboration of the inventive device, it is advisable for the transport speed of the transport system to be variable versus the conveying speed of the mail items to be franked and/or of the mail items carried by the conveyor system of the franking system in order either to retain their separation or to carry the mail items onward in an imbricated configuration with a selectable overlap. Of course, the speed used to form the transport stream on the transport system can be the same as that used for franking, but this would not make it possible to optimize the output of the franking system.

It has been found to be especially advantageous for the upstream end of the transport system to have a stop for the franked mail items carried away by the conveyor system from the franking system. This stop provides another way in which the distance between the mail items on the transport system can be influenced, and it can also prevent the mail items leaving the franking system from being conveyed too far to be accepted by the transport system.

The stop is preferably positioned a certain distance away from the upstream end of the transport system and is preferably adjustable. In cooperation with the positioning of the transport system in the conveying direction of the mail items, it can be used in particular to optimize the transport stream on the transport system.

The franked mail items can be transferred to the transport system more effectively if the downstream conveying end of the outfeed part of the franking system is set back from the transport system.

For the purpose of preferred types of further processing of the mail items, a receiving mechanism which backs up the mail items is installed at the conveying end of the transport system. This mechanism collects the arriving mail items into a pile or stack, so that they can be removed by hand.

For this purpose, the receiving mechanism is advantageously designed as a support, the position of which is adjustable and against which the mail items back up and become at least partially upright.

The support element can be adjusted as desired to assume various angles, so that the mail items which are backing up against it push each other upright and form a slanting stack, which can then be easily removed.

The support element can be pivoted to various angles around an axis transverse to the transport direction of the transport system, the angle being selected to suit the configuration of the stream of mail items.

Regardless of whether they are installed jointly or individually, the franking system and transport system can be connected detachably to each other.

For the sake of high transport speeds, among other things, it is advantageous for the transport belt of the transport system to be provided with through-openings and with an evacuatable chamber underneath the working strand. This chamber extends all the way to the conveying end of the transport system, more or less, so that the mail items remain on the perforated transport belt until they actually leave the transport system.

Alternatively, instead of a backing-up mechanism following the end of the transport system, a stacking unit can be provided to accept the mail items, which are dumped into the unit in such a way that they lie on top of each other.

For this purpose, it is suitable to use a rotary table as a stacking surface, which, to compensate for the different thicknesses of the mail items, can rotate around 180°, and which has a pre-collection device, which holds back the mail items while the table rotates.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is an elevational view of an inventive device;

FIG. 2 is a side view in the direction of arrow A in FIG. 1; and

FIG. 3 is a perspective view of the device shown in FIGS. 1 and 2.

### DETAILED DESCRIPTION OF THE INVENTION

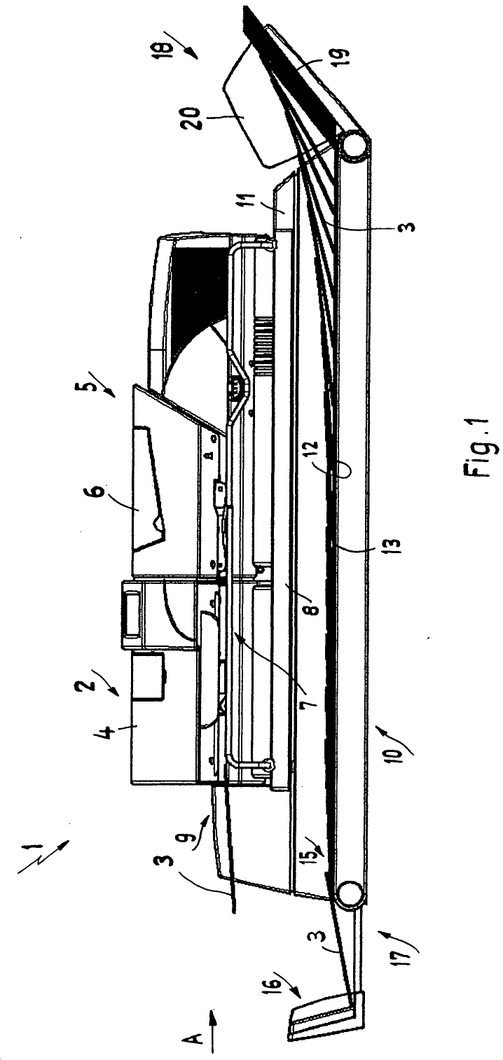

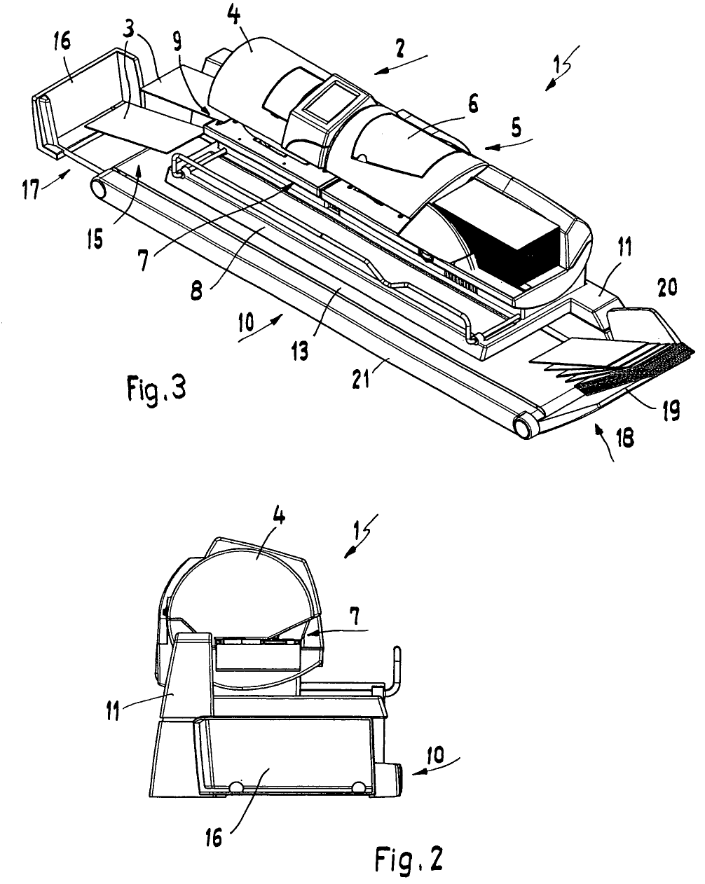

FIGS. 1-3 show a device 1 with a franking system 2 for franking and/or printing images on flat mail items 3 such as envelopes, cards, mailers, small packages, labels, printed products, etc. The franking system 2 consists of a franking unit 4, which provides the mail items 3 with a postage mark and/or advertising mark and/or information, where the franking unit 4 can be loaded by hand or by a mechanical feed mechanism 5. In FIG. 1, a feed mechanism can be seen, by means of which the mail items are removed individually from the bottom of a stack (not shown) and then sent by means of a loading device 6 to the franking unit 4. A usable automatic feed mechanism 5 for mail items 3 is described in EP 06405106.3.

A conveyor system 7 ensures a continuous flow of mail items 3 through the franking system 2, including the feed to the system, passage through the system, and outfeed from the system. The conveying line of the conveyor system 7 assigned to the franking system 2 could be called the “franking section”. FIG. 1 also shows that the franking system 2, also called a “franking machine” by those in the field, is mounted on a plate 8 or a table, the length of which is more-or-less the same as that of the franking system. The plate 8 can be attached to a stand 11, which rests on the floor (transportable), or to a wall (not shown). One conveying end 9 of the conveyor system 7 assigned to the franking system 2 leads to a transport system 10, which is located or extends underneath the franking system 2 and the conveyor system 7 and is driven in the direction opposite to that in which those systems operate. The transport system 10 has an endless traveling transport belt 12, which forms a working strand 13 on the top or conveying side, which faces the franking system 2 or conveyor system 7. The franked or printed mail items 3 fall onto this working strand by way of a drop-off (free-fall or delivery drop-off) formed by the conveyor system 7 and the transport system 10. The height of this drop-off is more than the thickness of the thickest mail item 3 to be transported by the transport system 109. The drop-off can also be designed so that it is variable, for which purpose it would be necessary for the distance between the conveyor system 7 and the transport system 10, which extends underneath and parallel to it and which forms a more-or-less horizontal conveying plane, to be adjustable. The transport belt 12 of the transport system 10 travels around two deflecting rolls 14 a certain distance apart, which have axles transverse to the transport direction, one of which is driven. The transport system has a side cover 21. Instead of an endless transport belt 12, it would also be possible to use a device with transport rolls, which form a conveying plane for the mail items 3 to be transported.

The conveying ends of the transport system 10 project beyond the conveyor system 7 and the franking system 2, so that the mail items 3, after they have been franked or printed, are dumped off from the conveying end of the conveyor system 7 onto the upstream conveying end 15 of the transport system 10, accepted by the latter, and transported onward in the opposite direction. So that trouble-free onward transport can be achieved, the transport system 10 is designed so that it can be adjusted along the length of the conveyor 7 and/or franking system 2; that is, the extent of the projection of the upstream conveying end of the transport system 10 can be selected to ensure trouble-free operation. The ideal projection depends on the format, on the weight, and/or on the speed of the mail items 3 passing through the franking operation.

By means of the transport speed of the transport system 10, i.e., of the working strand 13, can be selected accordingly, where the transport speed of the transport system 10 can also be a key factor in determining the configuration of the transported mail items 3. The higher the transport speed, the greater the gaps between the transported mail items 3 in the transport stream or the smaller the degree of overlap between them.

To support the transport stream and/or the proper configuration of the stream, a stop 16 for the franked and/or printed mail items 3 which have been carried away from the franking system 2 by the conveyor system 7 is installed at the upstream conveying end of the transport system 10. The stop 16 is responsible for changing the direction of the mail items 3 and supports the desired configuration of the mail items 3 being carried on the transport system 10. The stop 16 can be adjusted with respect to the upstream conveying end of the transport system 10, that is, brought closer to or farther away from it. For this purpose, as shown in FIGS. 1 and 3, a telescoping adjusting device 17 is illustrated. Because the way in which it functions is well known, there is no need for a separate description of it here.

So that the mail items 3 can be easily removed at the conveying end of the transport system 10, the transport system 10 preferably also projects beyond the upstream conveying end of the franking system 2 or its conveyor system 7, even if the former extends or projects by the maximum amount beyond the downstream conveying end of the franking system 2 or conveyor system.

At the conveying end of the transport system 10, a receiving mechanism 18 is provided, on which the mail items 3 accumulate to form a stack-like configuration. The receiving mechanism 18 has the effect of backing up the mail items 3 and of setting them upright and comprises a support element 19, which can be set to various angles around an axle oriented transversely to the transport direction of the transport system 10, and a lateral guide 20. To ensure free accessibility and ease of removal of the stack, the receiving device 18 projects beyond the franking system 2 and/or the conveyor system 7 arranged above it.

The franking system 2 and the transport system 10 are designed to be separable from each other, as a result of which an existing franking system 2 can be upgraded at a later date by the addition of the transport system 10, and a franking system 2 which is capable of being upgraded by the addition of a transport system 10 at a later date can also be operated by itself.

At high throughputs of mail items 3, the transport belt of the transport system 10 could be provided with through-openings, and the working strand could be guided over an evacuatable chamber installed underneath, which has the effect of holding the mail items on the working strand of the transport belt until they leave the chamber, i.e., the end of the transport route.

Following the conveying end of the transport system 10, it would also be possible to install a stacking device to lay the mail items on top of each other. This device could be advantageously comprise a rotary table and a precollecting mechanism arranged above it.

While specific embodiments of the invention have been shown and described in detail to illustrate the inventive principles, it will be understood that the invention may be embodied otherwise without departing from such principle.

I claim:

1. A process for franking, printing, and/or producing images on flat mail items such as envelopes, cards, mailers, labels, printed products, etc., by a franking system which includes a conveyor system for conveying the mail items through the franking system, the process comprising the conveyor system carrying the mail items in a row but a certain distance apart to a franking operation, and, after the franking operation carrying away the mail items, certain areas of which have been franked, printed, and/or provided with images, either individually one by one or in an imbricated stream, and transferring the mail items leaving the franking system a certain distance apart by way of a free-fall drop-off to an imbricated stream in which the distance between the individual mail items from each other is at least approximately equal to the size of the freshly franked area on the mail item.

2. The process according to claim 1, comprising transferring the mail items by way of the free-fall drop-off to an imbricated stream which is located underneath the franking system and which proceeds in a transport direction opposite to the conveying direction of the franking system, the distance between the transported mail items in the imbricated stream being at least approximately equal to the franked length of the mail item.

3. The process according to claim 1, comprising producing the imbricated stream by reducing the transport speed after the franking of the mail items.

4. The process according to claim 1, comprising using a stop which limits the path of the franked mail items to form the imbricated stream.

5. The device (1) for franking and/or printing images on flat mail items (3) by a franking system (2),
the franking system comprising a franking unit (4) for the franking and/or printing images on the mail items (3);
the franking system being configured for supplying the items individually to the franking unit (4), conducting the items through the unit, and carrying them away from the unit;
wherein a conveyor system (7) forming a franking section is part of the franking unit (4), the conveying end of this conveyor system leading to a transport system (10), wherein
the transport system (10) designed to accept and to transport the mail items (3) is located underneath the franking system (2) and is driven in a direction opposite to a conveying direction in which the mail items (3) to be franked by the franking system (2) are conveyed.

6. The device according to claim 5, wherein the conveying end of the conveyor system (7) and the transport system (10) are connected to each other for conveying by a free-fall drop-off.

7. The device according to claim 5, wherein the transport system (7) is an endless transport belt (12).

8. The device according to claim 5, wherein the transport system (10) comprises transport rolls arranged next to each other transversely to the transport direction.

9. The device according to claim 5, wherein the transport system (10) is movable and adjustable along the conveying line of the mail items (3) to be franked.

10. The device according to claim 5, wherein the transport speed of the transport system (10) can be changed versus the conveying speed of the mail items (3) to be franked.

11. The device according to claim 5, wherein a stop (16) for the franked mail items (3) which have been carried away from the franking system (2) by the conveyor system (7) is provided to an upstream end of the transport system (10).

12. The device according to claim 11, wherein the stop (16) is a certain adjustable distance away from the upstream end of the transport system (10).

13. The device according to claim 12, wherein the transport system (10) projects beyond a downstream conveying end of an outfeed mechanism of the franking system (2).

14. The device according to claim 5, wherein a receiving mechanism (18), which backs up the mail items, is installed at the conveying end of the transport system (10).

15. The device according to claim 14, wherein the receiving mechanism (18) comprises a support element (19), the position of which is adjustable.

16. The device according to claim 15, wherein the support element (19) can pivot to various angles around an axle oriented transversely to the transport direction of the transport system (10).

17. The device according to claim 11, wherein the receiving mechanism (18) located at the conveying end of the transport system (10) projects beyond the upstream end of the conveyor system (7).

18. The device according to claim 5, wherein the franking system (2) and the transport system (10) are arranged one above the other and are connected detachably to each other.

19. The device according to claim 11, wherein the transport belt (12) comprises through-openings and an evacuatable chamber underneath the working strand (13), which chamber extends at least approximately as far as the conveying end of the transport belt (12).

20. The device according to claim 11, wherein a stacking device which receives the mail items (3) so that they are lying on top of each other, is installed at the conveying end of the transport system (10).

21. The device according to claim 19, wherein the stacking device comprises a rotary table for accepting a stack of mail items and a pre-collecting mechanism arranged above the rotary table.
